(19) United States
(12) Patent Application Publication
(10) Pub. No.: US 2008/0301659 A1
(43) Pub. Date: Dec. 4, 2008

(54) Updating Software after Release

(75) Inventors: Miriam N. Rosenberg, Sammamish, WA (US); James G. Robertson, Issaquah, WA (US); Alia A. Nabawy, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/755,970

(22) Filed: May 31, 2007

(51) Int. Cl. G06F 9/44

(52) U.S. Cl. 717/168

(57) ABSTRACT

Aspects of the subject matter described herein relate to updating software after the software is released. In aspects, to install, configure, and/or manage new updates at least two installation paths are provided. In a first installation path, code within the software is patched, in part, to add new configuration screens with which to install, configure, and/or manage additional components associated with the update. In a second installation path, a configuration file associated with the software is changed. The software uses the configuration files to determine what components the software may install, uninstall, reinstall, configure, and/or manage. The configuration file may be updated so that the software can display different or new components.

### BACKGROUND

After releasing a software product to the public, there may be additional changes that are made to the product. Sometimes, these additional changes are released in another version of the product. At other times, some changes may be made available in-between major releases. Discovering and installing these interim releases, however, may be problematic.

### SUMMARY

Briefly, aspects of the subject matter described herein relate to updating software after the software is released. In aspects, to install, configure, and/or manage new updates at least two installation paths are provided. In a first installation path, code within the software is patched, in part, to add new configuration screens with which to install, configure, and/or manage additional components associated with the update. In a second installation path, a configuration file associated with the software is changed. The software uses the configuration files to determine what components the software may install, uninstall, reinstall, configure, and/or manage. The configuration file may be updated so that the software can display different or new components.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an exemplary environment in which aspects of the subject matter described herein may be incorporated;

FIG. 3 is a block diagram that generally represents actions that may occur in obtaining and installing a new update in accordance with aspects of the subject matter described herein;

FIG. 4 is a flow diagram that generally represents actions that may occur in a first installation path in accordance with aspects of the subject matter described herein;

FIG. 5 is a flow diagram that generally represents actions that may occur in a second installation path in accordance with aspects of the subject matter described herein; and

FIG. 6 is a block diagram that represents an exemplary device configured to operate in accordance with aspects of the subject matter described herein.

### DETAILED DESCRIPTION

### Exemplary Operating Environment

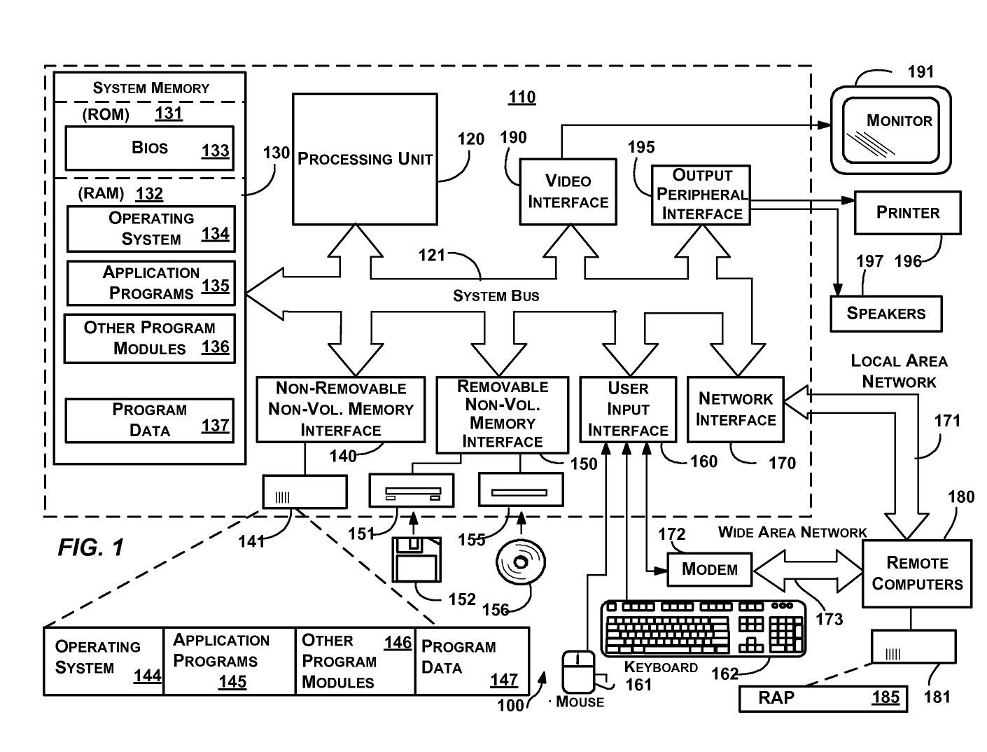

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Updating After Release

As described previously, changes may be made to a software product after the product has released. Some of these changes may be significant while others may be relatively insignificant. These changes may be made available by a service that notifies users of patches or updates that are available for a wide array of products. This service, however, may have coarse-grained classification for advertising available updates. For example, the service may proactively inform the user of updates that affect the stability or security of a computer system but may not proactively inform the user of updates that add new features or allow the computer system to perform new roles. As a result, users using such a service may not become aware that an update is available.

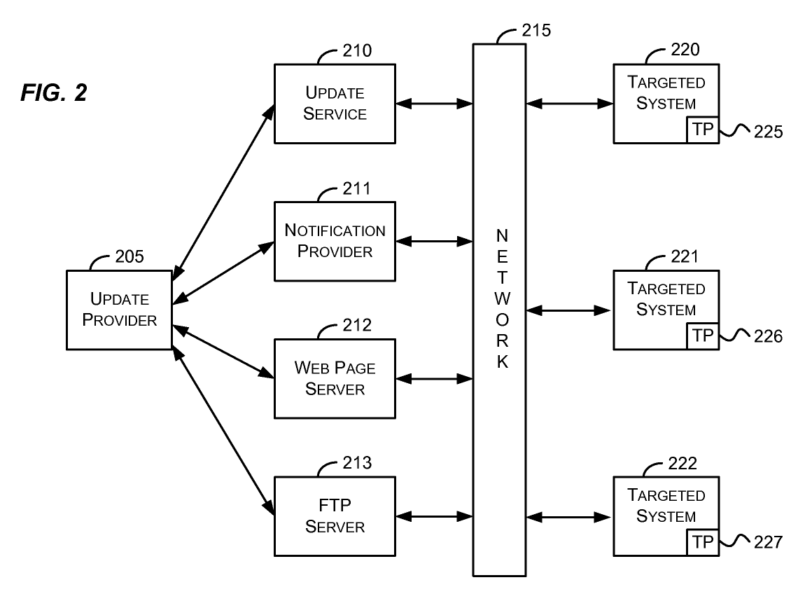

FIG. 2 is a block diagram that generally represents an exemplary environment in which aspects of the subject matter described herein may be incorporated. The environment includes an update provider 205, delivery mechanisms 210-213, a network 215, and targeted systems 220-222. Targeted systems 220-222 include targeted products 225-227, respectively.

The update provider 205 may be an entity that is involved in creating new or updated components or features. For example, a company may produce many components. Some of these components may be related to one product while others of these components may be related to another product or products. Some components may be intended to be distributed via a globally-accessible update mechanism that classifies the updates based on their affect on security or stability, for example.

Some components may be applicable to a targeted class of computer systems (e.g., computers that are running particular server software). Other components or updates may be targeted at other classes of computers systems (e.g., computers running a particular software package, computers running a particular operating system, computers having certain hardware characteristics, and the like).

The update provider 205 may notify and/or distribute updates to components or new components (hereinafter collectively referred to as “updates”) through a variety of delivery mechanisms 210-213. Some exemplary delivery mechanisms include an update service 210, a notification provider 211, a web page server 212, and a file transfer protocol (FTP) server 213. Other delivery mechanisms including sending a CD or other non-volatile computer-readable media having the updates stored thereon, broadcasting updates via a communications mechanism, placing an update in a shared folder on a given server, other update mechanisms, and the like may also be used without departing from the spirit or scope of aspects of the subject matter described herein.

The update service 210 may periodically notify registered systems of updates that are available. These updates may be automatically downloaded and installed or may be manually downloaded and/or installed depending on user preference. Each of the targeted systems 221 may include software that periodically polls the update server 210 for updates. In one embodiment, the update service 210 may provide updates for a particular type of component (e.g., operating system components) and may classify the updates according to how they affect system stability or security. In another embodiment, the update service 210 may provide updates for a wide range of components (e.g., operating systems, applications, server products, and so forth).

In one embodiment, to determine whether an update affects a targeted product (such as one of the targeted products 225-227), an administrator, user, or the like may periodically browse available updates to determine if one affects a given product. If so, the administrator or user may then download and install the update. Administrator as used herein refers to a computer administrator, user of the computer, or both.

In another embodiment, a software process may automatically check for updates. If the process finds an update it may be configured to notify an administrator of the updates and/or automatically download the updates.

The notification provider 211 may provide notification to the targeted systems 220-222 through various mechanisms including a popup window that indicates that updates are available, through e-mail to administrators associated with the systems 220-222, or via pull-mechanisms wherein a targeted product polls the notification provider 211 to query whether any relevant updates are available. The notification provider 211 may include software that parses all available updates and determines whether any of the targeted products 225-227 are interested in any of the available updates. An administrator of a targeted product may register with the notification provider 211 to have the notification provider 211 send notifications when updates of interest are available.

In another embodiment, the notification provider 211 may simply notify registered administrators or products when updates are available and may leave it to the administrators to go and view the available updates.

In some embodiments, an administrator may have the option of configuring a targeted system to automatically download or automatically download and install updates of interest.

The web page server 212 and the FTP server 213 may be used by an administrator or targeted product to download an update to a targeted system. After downloading, the update may be installed as described in more detail below.

The network 215 represents any mechanism and/or set of one or more devices for conveying data from one entity to another and may include intra- and inter-networks, the Internet, phone lines, cellular networks, networking equipment, direct connections between devices, wireless connections, and the like.

Examples of devices capable of hosting the services and software described above may include the special and general purpose electronic devices as described in conjunction with FIG. 1, cell phones, text messaging devices, smart phones, networking devices, combinations, portions, or variations of the above, and the like.

An update provider may have two or more types of updates. In one type of update, the update provider may wish to provide a richer user experience in downloading, installing, and/or configuring a product associated with the update. For example, when providing an update that allows a server to perform a new role (e.g., as a mail server), the update provider may wish to provide a wizard that guides the administrator through configuring the product.

Furthermore, the update provider may desire to have any updates to certain components managed through a common tool, among other mechanisms. For example, the tool may allow the administrator to view all the roles that a computer may perform and to select which ones the computer is to perform. When a component is selected, the tool may obtain a software package (e.g., from an update service) and guide the user through installing and configuring the software package. The tool may be able to uninstall and re-install the update as desired.

To provide this type of experience, in response to notification or after otherwise finding out that an update is available, the administrator may first update the tool. When it is updated, the tool may then be aware of additional updates that are available for download that may be managed by the tool. The tool may also include additional wizards or other configuration screens that assist the administrator in installing or configuring the additional updates. If desired, the update to the tool may also allow the tool to be used to manage roles and/or components. It will be appreciated that updating the tool in this manner may involve a significant development costs. Thus, this type of update may be reserved for a selected set of updates.

In another type of update, the update provider may be less concerned about providing a whole new set of wizards and configuration screens to install or configure a new update. The update provider may not wish to incorporate additional wizards and configurations screens into the tool. Rather, the update provider may simply wish to have the new update listed as a new feature in the product. In addition, the update provider may be satisfied with allowing the new update to have its own installation and configuration procedures.

In one embodiment, this type of experience may be provided by modifying a configuration file, registry key, or the like that the tool reads to determine the components the tool manages. As used herein, when it is indicated that a file is sent or modified to determine what components a tool can manage, in other embodiments, this may occur by changing or creating a registry key or modifying some other configuration data associated with the tool. The tool may list new components in a features section and allow the administrator to select any new component that the administrator desires to install. When the administrator selects a component, the tool may link to an installation program associated with the new component. In this type of update, updating the tool may involve sending a file (e.g., in XML) that indicates information about the new updates. The file may include, for example, the name of the update, a description of the update, and install, uninstall, and re-install commands that may be used to install, uninstall, and re-install the update as appropriate.

In this second type of update, the tool itself may not need to be updated to provide new wizards and configuration screens. Rather, the tool may just import or otherwise read the file that indicates the new updates and extend its list of available components as appropriate. It will be recognized that this mechanism for updating a targeted product may involve significantly less development costs than those of the first type.

Being aware of these two types of updates, the update provider may classify updates into one of two sets. In the first set, the update provider may place updates that will undergo a first installation path. In the second set, the update provider may place updates that will undergo a second installation path. In this manner, the update provider may be better able to control costs in providing the updates.

In one embodiment, a first class of updates may include updates related to a role a computer may perform. Some examples of new roles include components that provide directory services, terminal services, network access services, deployment services, print services, media services, rights managements services, sharing services, update services, UDDI services, certificate services, virtualization services, and file services, and components that allow a computer to act as a DHCP server, a DNS server, a fax server, an application server, a web server, and the like.

In another embodiment, a second class of updates may include updates that do not involve a new role that a computer may perform. Some examples of updates that may be classified in this second set include components that allow backup, file system features, failover clustering, load balancing, resource management, wireless network, simple TCP/IP services, RPC over HTTP proxy, SMTP server, telnet client, telnet server, SAN management, port monitoring, remote assistance, and the like.

In one embodiment, a first class of updates may include updates that update code (e.g., patch the code) within an existing component while a second set of updates may include those that involve updating a data structure that the existing component reads to create a user interface.

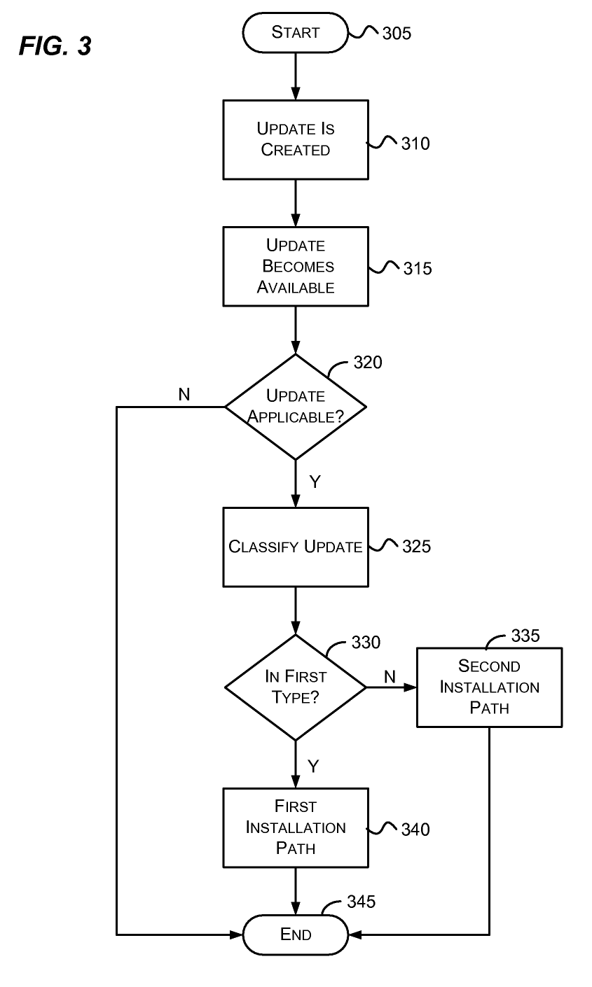

FIG. 3 is a flow diagram that generally represents actions that may occur in obtaining and installing a new update in accordance with aspects of the subject matter described herein. At block 305, the actions begin.

At block 310, the update may be created. For example, a set of one or more programmers may create a new update to be provided to a targeted set of computer systems.

At block 315, the update becomes available. For example, after testing and bug fixes, it may be deemed that the update is ready to be released to customers.

At block 320, a determination is made as to whether the update is applicable to a set of targeted products. If so, the actions continue at block 325; otherwise, the actions continue at block 345. For example, if an update is a graphics driver update, it may not be applicable to a product that manages server roles and features. If, on the other hand, the update can add terminal services, the update may be applicable to the product.

At block 325, the update is classified. The update may be classified into one of two or more types. As two exemplary types, the update may be classified as an update that modifies code in a software product or as an update that modifies configuration files of a software product without modifying the code of the software product.

At block 330, a determination is made as to whether the update is classified as having the first type. If so, the actions continue at block 335; otherwise, the actions continue at block 340.

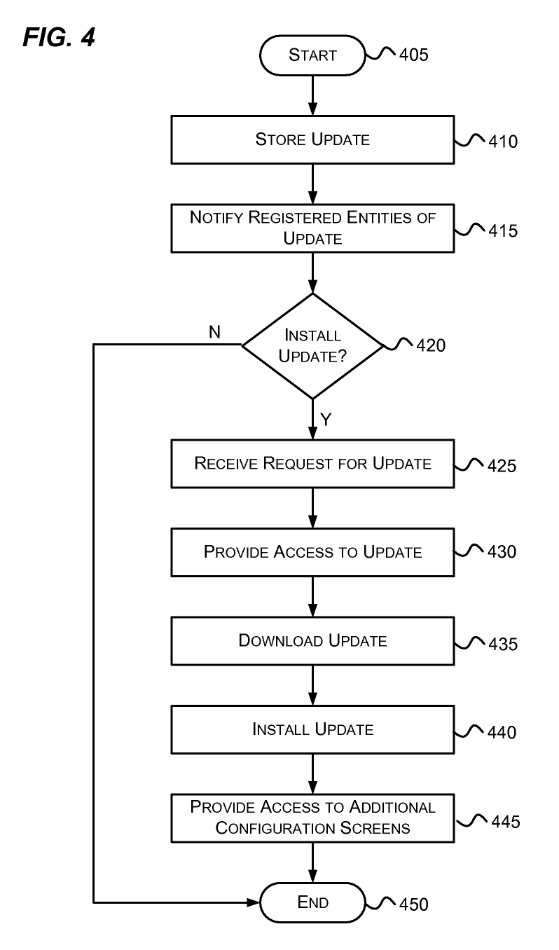

At block 335, a first installation path is provided by which the update may be installed. One exemplary first installation path is described in more detail below in conjunction with FIG. 4.

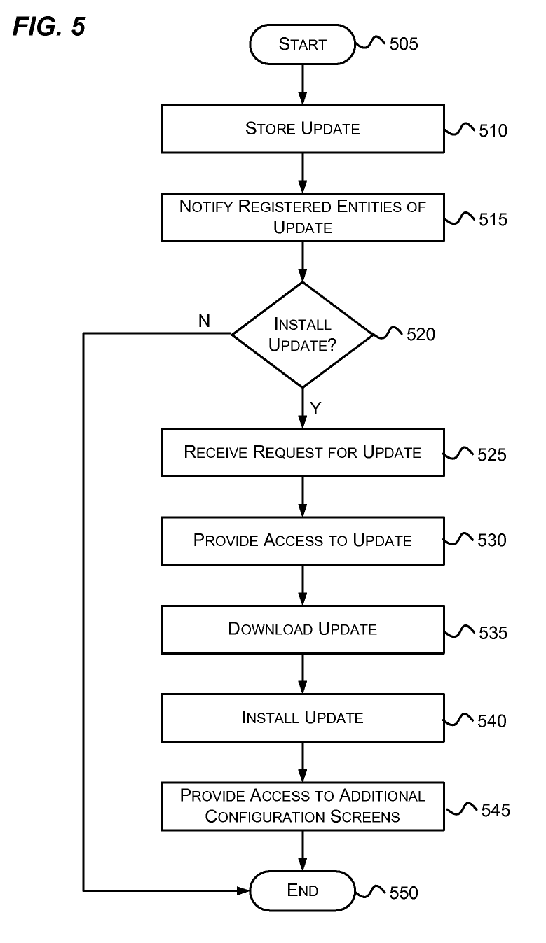

At block 340, a second installation path is provided. One exemplary second installation path is described in more detail below in conjunction with FIG. 5.

At block 345, the actions end.

FIG. 4 is a flow diagram that generally represents actions that may occur in a first installation path in accordance with aspects of the subject matter described herein. At block 405, the actions begin.

At block 410, the update is stored. For example, referring to FIG. 2, the update provider 205 places the update on the update server 210, the web page server 212, the FTP server 213, and/or some other delivery mechanism which then store the update.

At block 415, registered entities are notified of the availability of the update. For example, referring to FIG. 2, the notification provider 211 sends notifications to registered administrators of the targeted products 225-227.

At block 420, an administrator is given an opportunity to install the update. For example, a targeted product may display a dialog box that allows the administrator to install or not install the update. If the administrator decides to install the update, the actions continue at block 425; otherwise, the actions continue at block 450.

At block 425, a server receives a request for the update. For example, referring to FIG. 2, an administrator requests to download the update from the web page server 212. As another example, the targeted product 225 may request the update from the update service 210.

At block 430, the server provides access to the update. For example, in response to the request, the web page server 212 may provide access to the update to the administrator.

At block 435, the administrator's computer downloads the update. At block 440, the update is installed and may patch code on a component, for example.

At block 445, additional configuration screens may be provided to install additional components associated with the update. For example, the update may patch the code on a server administration tool. The patched code may include additional wizards or other configuration options that may include screens to configure additional components associated with the tool, for example.

At block 450, the actions end.

FIG. 5 is a flow diagram that generally represents actions that may occur in a second installation path in accordance with aspects of the subject matter described herein. At block 505, the actions begin. The actions that occur in blocks 510-535 may be similar to the actions that occur in blocks 410-435 of FIG. 4.

At block 540, the update is installed. In one embodiment, instead of patching code, a configuration file associated with a targeted product may be modified so that the targeted product displays additional components or features that are available.

At block 545, the additional software associated with the update is indicated, for example, through a user interface.

At block 550, the actions end.

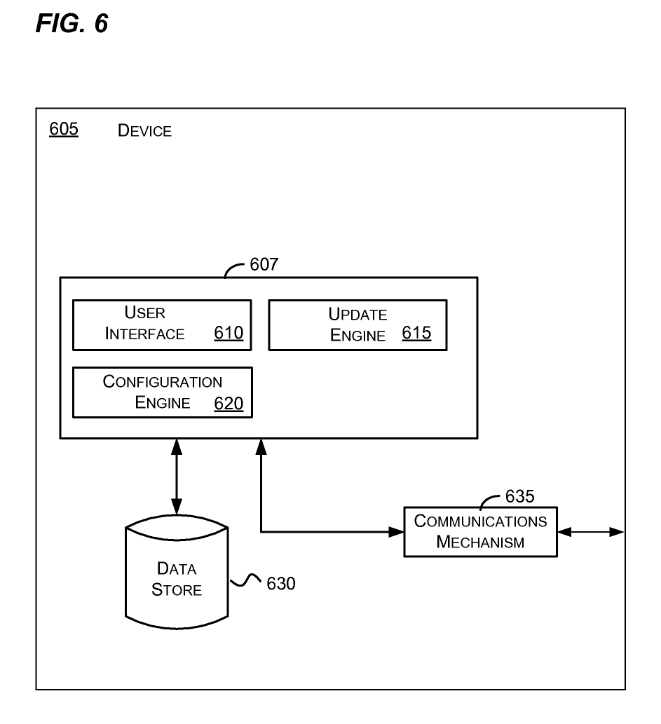

FIG. 6 is a block diagram that represents an exemplary device configured to operate in accordance with aspects of the subject matter described herein. In one embodiment, the device 605 may include a software product 607, a data store 630, and a communication mechanism 635. The software product may include a user interface component 610, an update engine 615, and a configuration engine 620.

The user interface component 610 provides screens and other user interface elements for communicating with an administrator. Through these screens an administrator may, for example, configure components associated with the software product 607.

The update engine 615 may receive notification of updates from a notification service, for example. For updates that involve changing data (and not code), the update engine may import the update to change data associated with the software product 607. For other updates, the update engine 615 may download the update from a server, query an administrator as to whether the administrator desires to install the update, and may initiate the installation process.

The configuration engine 620 may read a data structure to determine what components may be configured by the software product 607. The configuration engine 620 may interact with the user interface 610 to display wizards or other screens to configure these components and may install, uninstall, or re-install such components as described previously.

The data store 630 may include non-volatile memory that may be used to persist data across executions of the software product 607. The data store 630 may include the data the configuration engine 620 uses to configure components.

The communications mechanism 635 allows the device 605 to communicate with other devices to receive update notifications, download updates, and the like, for example. The communications mechanism 640 may be a network interface or adapter 170, modem 172, or any other means for establishing communications as described in conjunction with FIG. 1.

It will be recognized that other variations of the device 605 shown in FIG. 6 may be implemented without departing from the spirit or scope of aspects of the subject matter described herein. It will be recognized that more, fewer, or other components may exist on the device 605 without departing from the spirit or scope of aspects of the subject matter described herein.

As can be seen from the foregoing detailed description, aspects have been described related to updating software after the software is released. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
downloading an update, the update being classified into one of at least two types of updates, a first type of the at least two types of updates involving updates that patch code of a component, in part, to provide capability to the component to configure additional software that became available after the component was released, a second type of the at least two types of updates involving changing a data structure that the component uses, in part, to determine available software;
if the update is classified as the first type, providing a first installation path for installing the update; and
if the update is classified as the second type, providing a second installation path for installing the update.

2. The computer-readable medium of claim 1, wherein providing a first installation path for installing the update comprises displaying that the update is available and receiving input as to whether to install the update.

3. The computer-readable medium of claim 2, further comprising installing the update and thereafter providing access to a screen for configuring the additional software.

4. The computer-readable medium of claim 3, wherein configuring the additional software comprises downloading the additional software and installing the additional software based on information received in the screen.

5. The computer-readable medium of claim 4, further comprising uninstalling the additional software while keeping effects of the patch code within the component, the effects including code to re-install the additional software and configure the additional software via the screen.

6. The computer-readable medium of claim 1, wherein providing a second installation path for installing the update comprises adding an item to an existing list of available software in a user interface, the item indicating software associated with the update.

7. The computer-readable medium of claim 1, wherein providing a second installation path for installing the update comprises providing a link in the component to an installation package associated with the update.

8. The computer-readable medium of claim 7, further comprising uninstalling software associated with the installation package while maintaining information that indicates that the software associated with the installation package is still available for re-installation.

9. The computer-readable medium of claim 1, wherein the update includes a name and description of the update and wherein providing a second installation path for installing the update comprises integrating the name and description with other existing names and descriptions of software that is available.

10. The computer-readable medium of claim 1, wherein the second installation path is performed without using the component to install the update.

11. The computer-readable medium of claim 1, wherein providing a second installation path for installing the update comprises placing the update in a location in which the component looks to determine available software.

12. A method implemented at least in part by a computer, the method comprising:
storing an update, the update being classified into one of at least two types of updates, a first type of the at least two types of updates involving updates that patch code of a component, in part, to provide capability to the component to configure additional software that became available after the component was released, a second type of the at least two types of updates involving changing a data structure that the component uses in part to determine available software;
receiving a request for the update; and
in response to the request, providing access to the update.

13. The method of claim 12, further comprising selecting the update from a set of updates based on a targeted software product to which the update is applicable.

14. The method of claim 13, further comprising providing notification to registered administrators involved with the targeted software product.

15. The method of claim 13, wherein selecting the update from a set of updates based on a targeted software product to which the update is applicable comprises matching an identifier associated with the update with an identifier associated with the targeted software product.

16. The method of claim 12, wherein providing access to the update comprises placing the update on a Web or file transfer protocol server.

17. The method of claim 12, wherein providing access to the update comprises placing the update in a service that advertises updates to registered computers.

18. In a computing environment, an apparatus, comprising:
a user interface component operable to display screens for interacting with a software product;
an update engine operable to update the software product with an update, the update being classified into one of at least two types of updates, a first type of the at least two types of updates involving updates that patch code of a component, in part, to provide capability to the component to configure additional software that became available after the component was released, a second type of the at least two types of updates involving changing a data structure that is used, in part, to determine available software; and
a configuration engine operable to obtain data regarding installation options for available components, the data being included in the data structure.

19. The apparatus of claim 18, further comprising a data store that includes non-volatile memory for persistently storing the data structure.

20. The apparatus of claim 18, wherein the user interface component communicates with the configuration engine to obtain configuration options for the available components.
